(19) United States
(12) Patent Application Publication
(10) Pub. No.: US 2018/0345475 A1
(43) Pub. Date: Dec. 6, 2018

(54) Interchangeable Power Tool Device

(71) Applicant: XIANFENG QIAN, NINGBO (CN)

(72) Inventor: XIANFENG QIAN, NINGBO (CN)

(21) Appl. No.: 15/997,692

(22) Filed: Jun. 5, 2018

(30) Foreign Application Priority Data
Jun. 5, 2017 (CN) 201720640817.4

(51) Int. Cl. B25F 5/02; F16B 21/16; F16B 21/12

(52) U.S. Cl. CPC B25F 5/02; F16B 21/12; F16B 21/16

(57) ABSTRACT

An interchangeable power tool device is disclosed which comprises a driving chamber, and a tool connector. The driving chamber comprises a housing, a driving motor mounted inside the housing, a coupler, and a rotatable output shaft connected to the driving motor by the coupler. The rotatable output shaft protrudes from the housing along an axial direction of the driving motor. The tool connector includes a positioning base removably attached to the housing and a tool fixing component rotatably connected with the positioning base, and a coupling component to circumferentially limit the rotatable output shaft is provided on an end of the tool fixing component. Embodiments of the present disclosure provide a power tool device having a convenient interchangeable function for a tool connected to the tool connector and a smaller size.

### CROSS-REFERENCE TO RELATED APPLICATIONS

This application claims priority to Chinese Patent Application No. 201720640817.4 with a filing date of Jun. 5, 2017. The content of the aforementioned applications, including any intervening amendments thereto, are incorporated herein by reference.

### TECHNICAL FIELD

The present disclosure relates to the field of electric appliances, and more particularly, to an interchangeable power tool device.

### BACKGROUND

In prior arts, commonly used multifunctional power tools may use a positioning guide groove and electromagnetic fixing components to fix the tool connectors. More space within a driving chamber of the power tool would be required for installing the electromagnetic switch and the positioning guide groove. At the same time, an exterior force is needed to open or close the electromagnetic switch. It is often necessary to adjust the angle of the power tool when disassembling the connector to facilitate applying the exterior force before the disassembly can be completed.

### SUMMARY

One technical problem to be solved by the present disclosure is to provide an easy-to-replace function for the power tool that enables interchanging the tool connector in a convenient and labor-saving way.

An interchangeable power tool device according to an embodiment comprises a driving chamber, and a tool connector. The driving chamber comprises a housing, a driving motor mounted inside the housing, a coupler, and a rotatable output shaft connected to the driving motor by the coupler. The rotatable output shaft protrudes from the housing along an axial direction of the driving motor. The tool connector includes a positioning base removably attached to the housing and a tool fixing component rotatably connected with the positioning base, and a coupling component to circumferentially limit the rotatable output shaft is provided on an end of the tool fixing component.

In an embodiment, the positioning base comprises at least one circumferentially arranged positioning protrusion protruding in a radial direction. The positioning base comprises a through hole in the center for the rotatable output shaft to pass through. The housing comprises a positioning hole for connecting with the positioning base. The positioning hole has a positioning groove adapted to the positioning protrusion.

In an embodiment, a limiting groove extending tangentially along a peripheral wall of the positioning base is provided on a middle part of one of the at least one positioning protrusions. The middle part of the one positioning protrusion has a button arranged long an inner wall of the positioning hole to be axially limited by the limiting groove and a reset spring arranged between the button and the housing. A limiting block to be axially limited by the limiting groove is arranged on an end of the button. A movement groove for the one positioning protrusion to pass through is arranged on a side of the limiting block

In an embodiment, a guiding slope is formed on a connecting surface between the limiting block and the movement groove, and the width of the guiding slope decreases along a direction pointing from the limiting block to the movement groove.

In an embodiment, the at least one positioning protrusions comprises a rectangular protrusion.

In an embodiment, the at least one positioning protrusions comprises a plurality of angled protrusions.

In an embodiment, the at least one positioning protrusions comprises a plurality of arched protrusions.

In an embodiment, the tool fixing component is a collet component for clamping and rotating a work piece, and the coupling component comprises a sleeve hole to circumferentially limit the rotatable output shaft and a coupler fixed to the collet component.

In an embodiment, the tool fixing component is a fixing plug component for clamping and rotating a work piece, and the coupling component comprises a sleeve hole to circumferentially limit the rotatable output shaft and a coupler fixed to the fixing plug component.

In an embodiment, the tool fixing component has a U-shaped groove on the outside for preventing a saw blade from derailing during use.

Several beneficial effects can be achieved by the technical solution of the present disclosure. The tool connector is connected with the driving chamber through a detachable connection between the positioning base and the housing so as to avoid failures of the tool connector, such as a detachment of the tool connector and a sliding in the circumferential direction during the operation of the power tool. At the same time, the tool can be disassembled through the detachable connection to facilitate the replacement of the tool connector. By connecting the rotatable output shaft and the coupling component, the power of the driving chamber is transmitted to the tool connector, so that the tool fixing component may obtain driving power. The rotation of the positioning base when the tool connector is connected to the driving chamber is also prevented. The at least one positioning protrusions can effectively reduce gaps between the tool connector and the driving chamber. The axial movement of the tool connector relative to the driving chamber is prevented by the cooperation of the limiting block and the limiting groove. When the tool connector is being removed, the button is pressed to remove the positioning protrusions from the driving chamber through the movement grooves. When the tool connector is being connected, the limit block is moved to the limit groove to connect to the tool connector through the reset spring as the tool connector reaches its installation position. Meanwhile, the button is tangentially provided on the inner peripheral wall, so that the driving chamber has more installation space and a total size thereof can be reduced.

### BRIEF DESCRIPTION OF THE DRAWINGS

FIG. 1 is a structural schematic of an interchangeable power device according to an embodiment.

FIG. 2 is an explosive view of an interchangeable power device according to an embodiment.

FIG. 3 is a cross-section of a positioning base according to an embodiment.

FIG. 4 is a structural schematic of a button according to an embodiment.

FIG. 5 is a structural schematic of an interchangeable power device according to another embodiment.

### REFERENCE NUMBERS

1 tool connector 1.1 positioning base 1.1.1 rectangular protrusion 1.1.2 angled protrusion 1.1.3 arched protrusion 1.1.4 limiting groove 1.2 collet component 1.3 fixing plug component 2 drill 3 driving chamber 3.1 housing 3.2 rotatable output shaft 3.3 positioning hole 4 button 4.1 limiting block 4.2 guiding slope 4.3 movement groove 5 sleeve

### DETAILED DESCRIPTION

The embodiments of the present disclosure are discussed in further detail hereinafter with reference to the accompanying drawings.

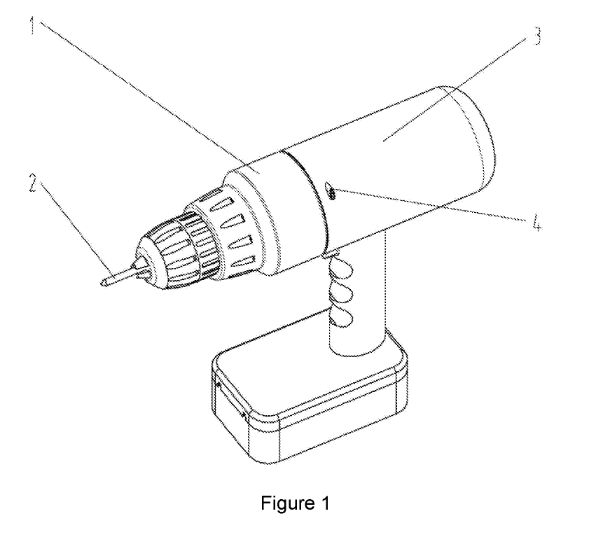

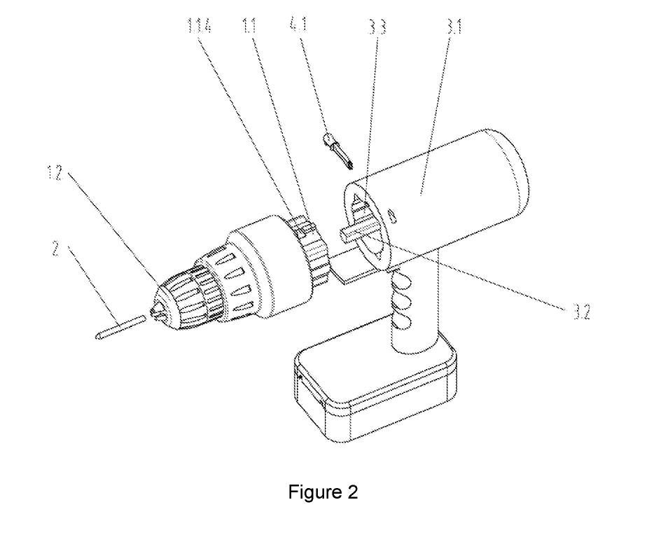

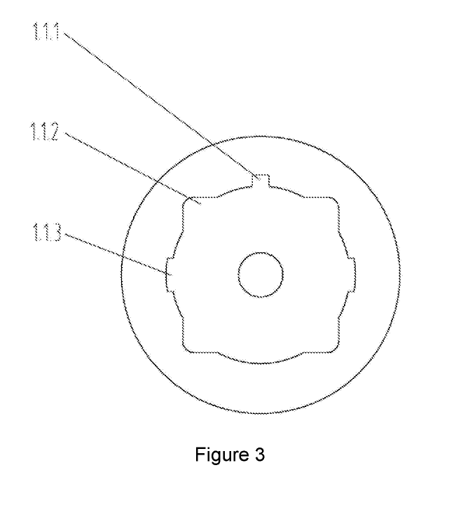

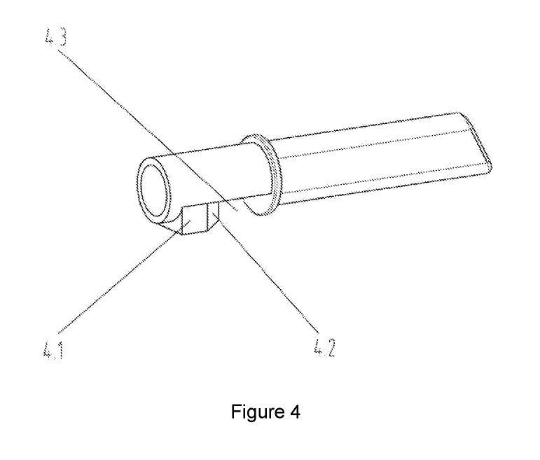

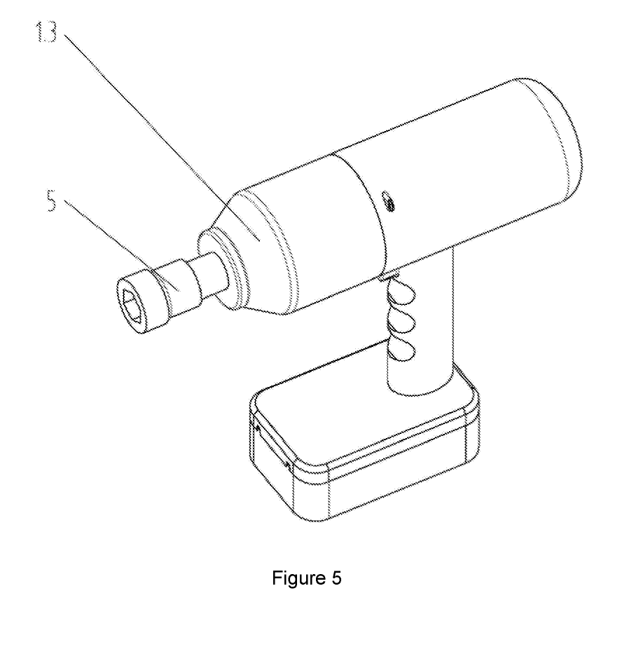

As shown in FIG. 1-5, the power tool with the interchangeable function of an embodiment is composed of a tool connector 1, a tool, and a driving chamber.

The tool connector 1 for clamping and rotating a work piece or a tool includes a positioning base 1.1 in detachable connection with the housing 3.1 and a tool fixing component in rotational connection with the positioning base 1.1. A plurality of radial positioning protrusions are arranged on the positioning base 1.1 in a circumferential direction. The positioning protrusions include a rectangular protrusion 1.1.1, four symmetrically distributed angled protrusions 1.1.3, and two symmetrically distributed arched protrusions 1.1.3. The middle part of the rectangular protrusion 1.1.1 is provided with a limiting groove 1.1.4 extending tangentially along the peripheral wall of the positioning base 1.1. The four angled protrusions 1.1.3 and two arched protrusions 1.1.3 are symmetrically distributed on both sides of an axis of symmetry which is the centerline of the rectangular protrusion 1.1.1. The tool fixing component may be a collet component 1.2 for holding a drill 2, a tap, and an Allen wrench. One end of the tool fixing component is provided with a coupling component to circumferentially limit the rotatable output shaft 3.2. A sleeve hole on the coupling component is used to circumferentially limit the rotatable output shaft 3.2. The coupling component is fixedly connected to the collet component. Therefore, the collet can be rotated when the output shaft 3.2 is rotated.

The driving chamber 3 includes a housing 3.1 and a driving component. The bottom of the housing 3.1 is connected with a battery box. The driving component includes a driving motor, a coupler, and an output power shaft. The driving motor is installed inside the housing 3.1. The rotatable output shaft 3.2 is connected to the driving motor through the coupler. A part of the rotatable output shaft 3.2 is projecting out of the housing 3.1 for connection with a sleeve hole on the tool fixing component. A positioning hole 3.3 is provided on the casing 3.1. The inner wall of the positioning hole 3.3 comprises a plurality of positioning grooves that are matched with the positioning protrusions in a circumferential direction. The tool connector 1 and the driving chamber can be accurately matched by the matching of the rectangular positioning protrusions and the corresponding positioning grooves. Radial relative movement during the connection of the tool connector 1 with the driving chamber 3 can be prevented through the matching of the four angled positioning protrusions and the corresponding positioning grooves. Circumferential relative movement during the connection of the tool connector 1 with the driving chamber 3 can be prevented through the matching of the two arched positioning protrusions and the corresponding positioning grooves. Influence of gaps between the tool connector 1 and the driving chamber 3 can be reduced by matching the plurality of positioning protrusions with the corresponding positioning grooves.

A button 4 axially limited by the limiting groove 1.1.4 and a reset spring provided between the button 4 and the housing 3.1 are arranged in the middle of a rectangular positioning groove along a tangent line of the inner wall of the positioning hole 3.3. One end of the button 4 comprises a limiting block 4.1 axially limited by the limiting groove 1.1.4. A movement groove 4.3 is provided on one side of the limiting block 4.1 for the positioning protrusion to pass through axially. A guiding slope 4.2 is formed on a connecting surface between the limiting block 4.1 and the movement groove 4.3. The width of the guiding slope 4.2 decreases along a direction pointing from the limiting block 4.1 to the movement groove 4.3. The other side of the limiting block 4.1 is provided with a spring hole for fitting the reset spring. The other end of the button 4 is protruding out of the housing 3.1. When the button 4 is pressed, the reset spring is compressed to move the rectangular protrusion within the movement groove 4.3. When the button 4 is released, the reset spring automatically resets the button 4, and the tool connector 1 is axially limited again.

When the tool connector 1 needs to be replaced, the button 4 can be pressed to disengage the limiting block 4.1 on the button 4 from the limiting groove 1.1.4 and cancel the axial limitation applied to the tool connector 1. Then the tool connector 1 may be removed along the axial direction of the positioning hole 3.3. When the button 4 is released, the button 4 will be returned to a position to fix the tool connector 1 by the reset spring. Then the positioning base 1.1 of the tool connector 1 to be mounted would correspond to the positioning hole 3.3, and the positioning base 1.1 is pushed into the positioning hole 3.3. During the pushing process, the rectangular protrusion 1.1.1 on the positioning base 1.1 will push the button 4 to an unlocking position along the guiding slope 4.2 of the button 4. The force applied to the button 4 during the pushing process can be decreased without requiring to fully push the button 4 to an alignment position wherein the movement groove 4.3 aligns with the rectangular protrusion 1.1. An automatic guiding function is thus achieved. After the positioning base 1.1 has completely entered the positioning hole 3.3, the positioning block 4.1 and the positioning groove 1.1.4 are aligned on the same tangent line of the same cross section. Due to the restoring force of the reset spring, the limit block 4.1 is moved into the limit groove 1.1.4 to axially limit the tool connector 1.

When a rotatable tool, such as a drill 2, a tap, or an Allen wrench is to be used, the collet component 1.2 is adopted for the tool connector 1. The transmission sequence of the driving motor, the rotatable output shaft 3.2, the coupling component, the collet component, and tool implements the rotation of the tool.

When a rotatable tool, such as a sleeve 5 is to be used, the fixing plug component 1.2 is adopted for the tool connector 1. The transmission sequence of the driving motor, the rotatable output shaft 3.2, the coupling component, the fixing plug component, and tool implements the rotation of the tool.

I claim:

1. An interchangeable power tool device, comprising:
a driving chamber (3), and a tool connector (1), wherein the driving chamber (3) comprises a housing (3.1), a driving motor mounted inside the housing, a coupler, and a rotatable output shaft (3.2) connected to the driving motor by the coupler, the rotatable output shaft protrudes from the housing along an axial direction of the driving motor, the tool connector (1) includes a positioning base (1.1) removably attached to the housing and a tool fixing component rotatably connected with the positioning base (1.1), and a coupling component to circumferentially limit the rotatable output shaft (3.2) is provided on an end of the tool fixing component.

2. The device of claim 1, wherein the positioning base (1.1) comprises at least one circumferentially arranged positioning protrusion protruding in a radial direction, the positioning base (1.1) comprises a through hole in the center for the rotatable output shaft (3.2) to pass through, the housing (3.1) comprises a positioning hole (3.3) for connecting with the positioning base (1.1), and the positioning hole (3.3) has a positioning groove adapted to the positioning protrusion.

3. The device of claim 2, wherein a limiting groove (1.1.4) extending tangentially along a peripheral wall of the positioning base (1.1) is provided on a middle part of one of the at least one positioning protrusions, the middle part of the one positioning protrusion has a button (4) arranged long an inner wall of the positioning hole (3.3) to be axially limited by the limiting groove (1.1.4) and a reset spring arranged between the button (4) and the housing (3.1), a limiting block (4.1) to be axially limited by the limiting groove (1.1.4) is arranged on an end of the button (4), and a movement groove (4.3) for the one positioning protrusion to pass through is arranged on a side of the limiting block (4.1)

4. The device of claim 3, wherein a guiding slope (4.2) is formed on a connecting surface between the limiting block (4.1) and the movement groove (4.3), and the width of the guiding slope (4.2) decreases along a direction pointing from the limiting block (4.1) to the movement groove (4.3).

5. The device of claim 4, wherein the at least one positioning protrusions comprises a rectangular protrusion (1.1.1).

6. The device of claim 5, wherein the at least one positioning protrusions comprises a plurality of angled protrusions (1.1.2).

7. The device of claim 5, wherein the at least one positioning protrusions comprises a plurality of arched protrusions (1.1.3).

8. The device of claim 5, wherein the tool fixing component is a collet component (1.2) for clamping and rotating a work piece, and the coupling component comprises a sleeve hole to circumferentially limit the rotatable output shaft (3.2) and a coupler fixed to the collet component.

9. The device of claim 5, wherein the tool fixing component is a fixing plug component (1.3) for clamping and rotating a work piece, and the coupling component comprises a sleeve hole to circumferentially limit the rotatable output shaft (3.2) and a coupler fixed to the fixing plug component.
